(19) United States
(12) Patent Application Publication
(10) Pub. No.: US 2006/0245737 A1
(43) Pub. Date: Nov. 2, 2006

(54) Combining different content discs for playback of supplemental content

(76) Inventors: Philip M Walker, Fort Collins, CO (US); Paul A. Boerger, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/119,190

(22) Filed: Apr. 29, 2005

(51) Int. Cl. H04N 7/26

(52) U.S. Cl. 386/112

(57) ABSTRACT

A first disc is used as a playback key for video content on a second disc. The content on a first disc is combined with content on another disc to provide: video having a second, increased resolution; a different aspect ratio; or, supplemental video or audio content.

### FIELD OF THE INVENTION

This application relates to video disc technology and more particularly to a scheme for allowing the video, audio, size, or resolution of existing content to be upgraded or supplemented.

### BACKGROUND OF THE INVENTION

As optical digital storage media technology has advanced, the amount of video data, or content, has increased. For example, a CD-ROM (compact disc) holds about 650 megabytes of data. This is enough for about 20 minutes of video data at a resolution of 352×240 pixels. A newer technology, DVD's (digital video disk or digital versatile disk) may hold upwards of 7 times the amount of data as a CD-ROM. This is enough for several hours of video content at a resolution of 720×480. Newer optical storage technologies, such as Blu-Ray and HD-DVD will have even higher capacities so that they will be able to hold several hours of video content at resolutions of 1920×1080 or higher.

One barrier to the adoption of these new technology discs is the existing movies on disc that consumers already own. In other words, people are slow to purchase or adopt these new formats because it would mean buying new discs, at full price, for videos they already own.

Accordingly, there is a need in the art for a scheme that increases the incentives for owners of older format video discs to upgrade to newer disc formats and content.

### SUMMARY OF THE INVENTION

The content on a first disc is combined with content on another disc to provide: video having a second, increased resolution; a different aspect ratio; or, supplemental video or audio content.

### BRIEF DESCRIPTION OF THE DRAWINGS

FIG. 1 is a flowchart illustrating steps for using an optical disc as a playback key using only a single disc drive.

FIG. 2 is a flowchart illustrating steps for using an optical disc as a playback key using multiple drives or additional storage media.

FIG. 3 is a flowchart illustrating steps for combining video data from two different resolution sources to enable playback of higher resolution content.

FIG. 4 is an illustration showing how lower resolution video content may be combined with upgrade-only high resolution content to enable playback of higher resolution content.

### DETAILED DESCRIPTION OF THE PREFERRED EMBODIMENTS

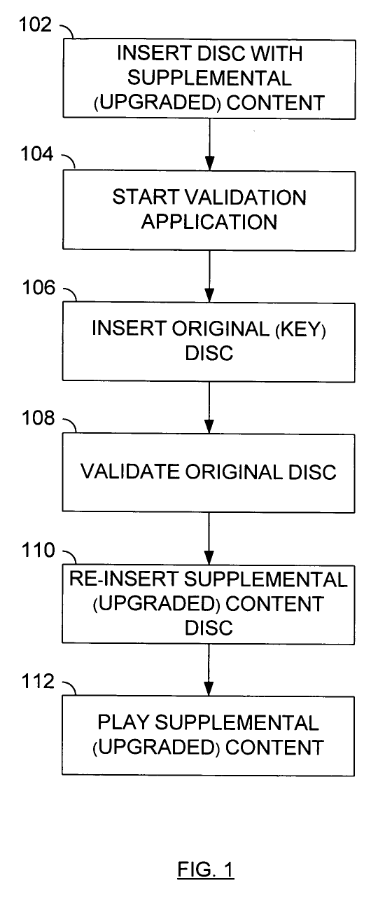

FIG. 1 is a flowchart illustrating steps for using an optical video disc or other digital media as a playback key using only a single disc drive. In a step 102, a video disc with supplemental, upgraded, high definition or higher resolution (HD) content is inserted into a disc drive. In a step 104, a validation application is started. This application may reside on the inserted disc; may be stored in the disc drive itself; or, may be part of the playback software. In one embodiment for a Blu-Ray disc drive, the validation application is a BD-J application. A BD-J application is further described and detailed in “White paper Blu-ray Disc Format 2.B Audio Visual Application Format Specifications for BD-ROM” and other technical documentation and specifications available from the Blu-ray Disc Association (www.blu-raydisc.com).

In a step 106, the original, non-upgraded, lower or standard definition (SD) disc is inserted in the disc drive. In a step 108, the validation application validates the original disc. The validation application may determine the authenticity of the original disc by determining that the inserted disc is stamped media and not write-once or read/write media and by checking the content of the disc matches the content of a legitimate original. A method of checking that the content matches the content of a legitimate original may include scanning selective portions of the disc and comparing those portions to known authentic content on those portions. Another method may be to scan portions or the entire disc and produce an encryption signature that may be compared to a known value. Additional validation may consist of any existing or future techniques that permit legitimate discs to be distinguished from bootleg copies on stamped media.

After validation is complete, in a step 110, the HD disc is re-inserted into the disc drive. In a step 112, the HD content is allowed to be played or accessed at a higher resolution than the original disc.

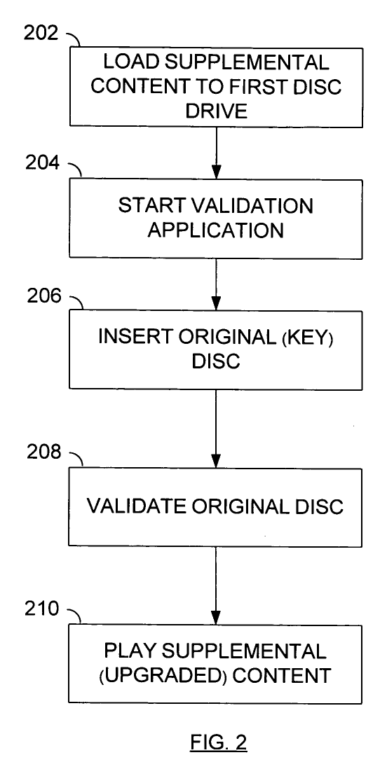

FIG. 2 is a flowchart illustrating steps for using a disc as a playback key using multiple drives or additional storage media. In a step 202, HD content is loaded to a first disc drive or other media. In one embodiment, this may comprise copying the HD content onto a hard disc drive or other media. The HD content may be copied from network sources (such as downloading from the internet) or may be copied from the disc media itself. In another embodiment, loading the HD content may comprise inserting a disc with the HD content into a disc drive.

In a step 204, a validation application is started. Embodiments of a validation application are disclosed in the discussion of FIG. 1, above. In a step 206, the SD disc is inserted in a second disc drive. This disc drive is a different drive than the drive containing the HD content, either because the HD content has been copied to a read/write hard drive, or because the system contains two removable media disc drives. In a step 208, the validation application validates the original disc. Methods whereby the validation application validates the original disc are disclosed in the discussion of FIG. 1, above. In a step 210, the HD content is played. During this step, the original SD disc may or may not be required to be present in the disc drive to maintain validation and thereby keep playing the HD content.

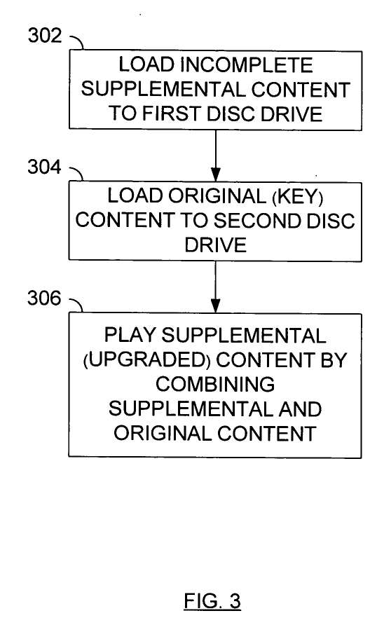

FIG. 3 is a flowchart illustrating steps for combining data from two sources to enable playback of higher resolution content. In a step 302, incomplete HD content that is incomplete, degraded, or otherwise dependent upon the original SD content for complete high resolution output content is loaded to a first disc drive. As discussed above, this loading may be onto or into a read/write hard drive via copying, the internet or other means, or by inserting media into one drive of a system that contains more than one removable media disc drives. In a step 304, the SD content is loaded into or onto the same or a second disc drive. As in step 302, this loading may be onto or into a read/write hard drive via copying, the internet or other means, or by inserting media into one drive of a system that contains more than one removable media type disc drives. In a step 306, the HD content is played by combining the HD and SD content.

Methods of combining the HD and SD content may include adding, subtracting, exclusive-OR'ing, multiplying, or other logic or math functions or a combination thereof. The combining function may be done on a pixel by pixel basis, or at a different granularity. For example, in one embodiment, the content of one block (which is an arbitrary size of SD data) of the SD content could be used as the input from the SD content to be combined with another block (of the same or different size as the SD block) of the HD content. Another embodiment would be to use a block of the SD content as a repeating pattern that is combined with the HD content. These blocks of SD and HD data may be of arbitrary or convenient sizes. For example, a disc sector, pixel row, pixel field or frame, or any other fixed or variable size. Another embodiment combines the SD and HD content on a pixel by pixel, frame by frame basis. In other words, each pixel of each field of the output high resolution content is produced from a combination of a corresponding pixel of a corresponding field of the HD content combined with a combination of corresponding pixel or combination of pixels in a corresponding field of the SD content. Note that in some cases, such as an upgrade from a 4×3 aspect ration to a 16:9 aspect ratio, there may be pixels in the HD content that do not directly correspond to a pixel or combination of pixels in the SD content. In this case, the HD content for these pixels may be used without first combining with some portion of the SD content. In the alternative, HD content for pixels with no corresponding SD pixel (or pixels), other methods of combining with the SD content may be used. One such method is to combine the HD content with some non-corresponding pixel or combination of pixels in the SD content.

The combination of the two blocks may be done by block combiner hardware such as microprocessor, graphics processor, custom ASIC or other hardware capable and programmed for the appropriate logical or mathematical functions.

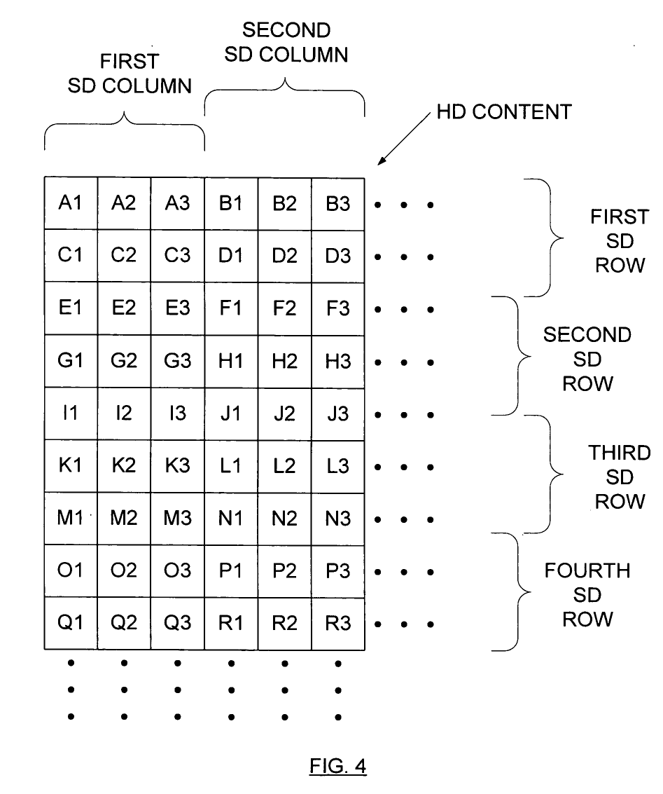

FIG. 4 is an illustration showing how standard definition (SD) content may be combined with upgrade-only high resolution (HD) content. This embodiment combines upgrade only HD content at a resolution of 1920×1080 with SD content at a resolution of 640×480. In FIG. 4, each pixel in the high resolution output (1920×1080) content is shown and labeled A1, A2 . . . B1, B2 . . . etc. Likewise, an overlay of the lower resolution (640×480) original content is labeled. Other and multiple combinations of resolution combining are contemplated. This combination is for illustrative purposes only.

The embodiment of FIG. 4 is meant to be an example only. The purpose of the illustrated combination technique is to associate each HD content pixel with one or more SD pixels that are roughly or exactly in the same region of visual content. If an HD pixel overlaps a boundary between two or more SD pixels, either in the vertical or horizontal directions, the output higher resolution content HD pixel is derived from some combination of those SD pixels that it either overlaps or is near.

To create the first row of the output higher resolution content, HD data intended for pixels A1, A2, and A3, respectively, is combined with the data for the SD pixel in the first column and first row of the SD content. Data intended for pixels B1, B2, and B3, respectively, is combined with the SD data for the pixel in the second column and first row of the SD original content. This is repeated with the appropriate SD and HD content being combined until the first row of output higher resolution content is complete.

The second row of higher resolution output content is created much the same way as the first row. HD data intended for pixels C1, C2, and C3 is combined with the data for the pixel in the first column and first row of the SD content. HD data intended for pixels D1, D2, and D3 is combined with the data for the pixel in the second column and first row of the SD content. This is repeated with the appropriate SD and HD content being combined until the second row of output higher resolution content is complete.

The third row of output higher resolution content is created differently. For the third row, a combination of the pixels in the first and second SD rows is combined with the HD content to produce the output higher resolution content. To produce pixels E1, E2, and E2, the HD data intended for these pixels is combined with an SD value produced by taking ¼ times the value of the SD pixel in the first SD row and the first SD column and combining (for example, adding) it with ¾ times the value of the SD pixel in the second SD row and the first SD column. To produce pixels F1, F2, and F3, the HD data intended for these pixels is combined with a value produced by taking ¼ times the value of the SD pixel in the first SD row and the second SD column and combining it with ¾ times the value of the SD pixel in the second SD row and the second SD column. This process is repeated with the appropriate SD and HD content until the second row of output higher resolution content is complete.

The fourth row of output higher resolution content is created much the same way as the first row. HD data intended for pixels G1, G2, and G3 is combined with the SD data for the pixel in the first column and second row of the SD content. Data intended for pixels H1, H2, and H3 is combined with the data for the SD pixel in the second column and second row of the SD original content. This is repeated with the appropriate SD and HD content until the fourth row of output higher resolution content is complete.

For the fifth row of output higher resolution content, a combination of the pixels in the second and third SD rows is combined with the HD content to produce output higher resolution content. To produce pixels I1, I2, and I2, the HD data intended for these pixels is combined with a value produced by taking ½ times the value of the SD pixel in the second SD row and the first SD column and combining it with ½ times the value of the SD pixel in the third SD row and the first SD column. To produce pixels J1, J2, and J3, the HD data intended for these pixels is combined with a value produced by taking ½ times the value of the SD pixel in the second SD row and the second SD column and combining it with ½ times the value of the SD pixel in the third SD row and the second SD column. This process is repeated with the appropriate SD and HD content until the fifth row of HD upgraded content is complete.

The sixth row of output higher resolution content is created much the same way as the first row. HD data intended for pixels K1, K2, and K3 is combined with the data for the SD pixel in the first column and third row of the SD content. HD data intended for pixels K1, K2, and K3 is combined with the SD data for the pixel in the second column and third row of the SD content. This is repeated with the appropriate SD and HD content until the sixth row of output higher resolution content is complete.

For the seventh row of HD upgraded content, a combination of the pixels in the third and fourth SD rows is combined with the HD content to produce the output higher resolution content. To produce pixels M1, M2, and M3, the HD data intended for these pixels is combined with a value produced by taking ¾ times the value of the SD pixel in the third SD row and the first SD column and combining (for example, adding) it with ¼ times the value of the SD pixel in the fourth SD row and the first SD column. To produce pixels N1, N2, and N3, the HD data intended for these pixels is combined with a value produced by taking ¾ times the value of the SD pixel in the third SD row and the second SD column and combining it with ¼ times the value of the SD pixel in the third SD row and the second SD column. This process is repeated with the appropriate SD and HD content until the seventh row of the output high resolution content is complete.

The eighth row of output high resolution content is created much the same way as the first row. HD data intended for pixels O1, O2, and O3 is combined with the SD data for the pixel in the first column and fourth row of the SD content. HD data intended for pixels P1, P2, and P3 is combined with the SD data for the pixel in the second column and fourth row of the SD content. This is repeated with the appropriate SD and HD content until the fourth row of output high resolution content is complete.

The ninth row of output high resolution content is created much the same way as the first row. HD data intended for pixels Q1, Q2, and Q3 is combined with the SD data for the pixel in the first column and fourth row of the SD content. HD data intended for pixels R1, R2, and R3 is combined with the SD data for the pixel in the second column and fourth row of the SD content. This is repeated with the appropriate SD and HD content until the fourth row of output high resolution content is complete.

This nine row pattern of combining pixels from the SD content and HD content is then repeated to produce a full output high resolution frame that is a combination of SD content and HD content. This frame has a resolution of 1920×1080.

What is claimed is:

1. A method of allowing access to higher resolution video content on a digital storage media, comprising:
reading a first block of video content data stored at a first resolution from a first portion of a first digital storage media;
reading a second block of incomplete video content data stored at a second resolution from a first portion of a second digital storage media;
combining said first block and said second block to form a third block of video content data at said second resolution that is complete.

2. The method of claim 1, wherein said first block of video content is a sector on a disc.

3. The method of claim 1, wherein said third block of video content data is a video field.

4. The method of claim 1, wherein said combining is addition.

5. The method of claim 1, wherein said combining is addition on a pixel by pixel basis.

6. The method of claim 1, wherein said combining is a combination of a corresponding pixel of a corresponding field of said second block of incomplete video content data combined with a corresponding pixel in a corresponding field of said first block of video content data.

7. The method of claim 6, wherein said combining is addition and said second block of incomplete video content data is comprised of differences between complete output pixels and said corresponding pixel in a corresponding field of said first block of video content data.

8. An apparatus for playing incomplete video content data stored on a first digital storage media, comprising:
means for reading a first block of said incomplete video content data stored at a first resolution from a first portion of a first digital storage media;
means for reading a second block of video content data stored at a second resolution from a first portion of a second digital storage media;
means for combining said first block and said second block to form a third block of video content data at said second resolution that is complete.

9. The apparatus of claim 8, wherein said third block of video content is a video field.

10. The apparatus of claim 8, wherein said combining is addition.

11. The apparatus of claim 8, wherein said combining is addition on a pixel by pixel basis.

12. The apparatus of claim 8, wherein said combining is a combination of a corresponding pixel of a corresponding field of said second block of incomplete video content data combined with a corresponding pixel in a corresponding field of said first block of video content data.

13. The apparatus of claim 12, wherein said combining is addition and said second block of incomplete video content data is comprised of differences between complete output pixels and said corresponding pixel in a corresponding field of said first block of video content data.

14. A system for playing incomplete video content, comprising:
a first digital storage media reader for reading a first digital storage medium containing incomplete video content at a first resolution, wherein said incomplete video content comprises a first set of pixels;
a second digital storage media reader for reading a second digital storage medium containing lower resolution video content at a second resolution, wherein said lower resolution video content comprises at least one pixel;
a block combiner that combines multiple pixels from said first set of pixels with said at least one pixel to produce a second set of pixels at said first resolution.
